(19) United States
(12) Patent Application Publication
(10) Pub. No.: US 2015/0247914 A1
(43) Pub. Date: Sep. 3, 2015

(54) METHOD AND DEVICE FOR ESTIMATING A DISTANCE

(71) Applicant: FLARM TECHNOLOGY GMBH, Baar (CH)

(72) Inventors: Urs Rothacher, Oakland, CA (US); Urban Mader, Zurich (CH)

(21) Appl. No.: 14/433,440

(22) PCT Filed: Oct. 5, 2012
(86) PCT No.: PCT/CH2012/000233

§ 371 Date: Apr. 3, 2015

(51) Int. Cl. G01S 5/02; G08G 5/04; G08G 5/00

(52) U.S. Cl. CPC G01S 5/021; G01S 5/0284; G08G 5/0095; G01S 5/0278; G08G 5/04

(57) ABSTRACT

An improved method for avoiding mid-air collision in aviation is disclosed. The method relies on a calibration of radio signal intensities I with radio signal encoded position information L. In other words, after a first reception of a radio signal S advantageously comprising remote aircraft position information L, the radio signal intensity I is measured and a correction factor C is derived. During a next encounter of the radio signal S, a second distance estimation d can be derived using the signal intensity I and the correction factor C. Preferably, relative positioning data is acquired together with the correction factor C and a plurality of correction factors for different relative positions is combined in an at least partly continuous correction function.

### TECHNICAL FIELD

The present invention relates to a method for deriving a correction factor for improving the precision of a distance estimation. Furthermore, the present invention relates to a method and device for deriving such an improved distance estimation using such a correction factor, in particular for use in aviation and vehicles.

### INTRODUCTION AND BACKGROUND ART

State-of-the-art traffic-awareness collisionwarning devices for aviation (such as FLARM, see, e.g., http://www.flarm.com/as accessed on May 13, 2012) constantly monitor their own three-dimensional (3D) position, e.g., via GNSS (Global Navigation Satellite Systems), inertial navigation systems, or combined data. This 3D position information (called “second position inn formation” herein) is then transmitted encoded in a digital radio signal. FLARM devices in other aircraft receive this radio signal, decode the associated 3D position information, display the other aircraft position, and compare this 3D position to their own 3D position (called “first position information” herein) from their own GNSS. A collision warning is then issued to the pilot as soon as an actual distance and/or a projected trajectory distance in the future between the two FLARM devices decreases below a distance threshold. Although proven highly reliable and very useful to prevent mid-air collisions, such collision-warning devices have the disadvantage to be blind to aircraft which are not equipped with FLARM systems.

As an improvement, collision-warning devices such as PowerFLARM (see, e.g., www.powerflarm.aero as accessed on May 13, 2012) furthermore monitor the signal intensities of “foreign”, i.e., non-FLARM radio signals such as ADS-B or transponder signals that are, e.g., transmitted by many aircraft. A distance estimation is then derived from the intensity of these signals and a collision warning is issued to the pilot as soon as this estimated distance decreases below the distance threshold. However, such distance estimations that are solely based on radio signal intensities are rather coarse as they strongly depend on, e.g., receiver antenna mounting position and other factors.

### DISCLOSURE OF THE INVENTION

Hence it is a general objective of the present invention to at least in part overcome these disadvantages.

These objectives are achieved by the device and methods of the independent claims.

Accordingly, a method for deriving at least one correction factor for at least one first estimation of a distance (or equivalently “distance estimation”) between a first position of at least one receiver (e.g., a receiver in one's own aircraft) and a second position of at least one transmitter (e.g., a transponder in a remote aircraft) comprises the following steps:
Receiving by means of said receiver at least one radio signal which is transmitted by said transmitter.
A signal intensity of the (advantageously pre-filtered) received radio signal is measured at the first position of the receiver (e.g., in the above example in one's own aircraft).
Using this measured radio signal intensity, the first distance estimation between the first position (e.g., own aircraft position) and the second position (e.g., foreign aircraft position) is optionally derived, e.g., using an assumed 1/d² (with d being the true distance between the first and the second position) dependency of radio signal intensity.

Now, because such a first distance estimation is rather coarse, a correction factor for the estimated distance is derived in the following way:
Second position information, i.e., information which is indicative of the second position of the transmitter (e.g., the remote aircraft position in the above example) is derived.

This is advantageously achieved, when the radio signal comprises said second position information indicative of said second position of said transmitter. In other words, the second position information is transmitted with the radio signal.

For this, the radio signal advantageously comprises at least one of the group of
an ADS-B Out signal (from a remote ADS-B Out capable transponder), and
a FLARM signal (from a remote FLARM system), and a Mode C response signal (from a remote transponder).

Alternatively (e.g., when the radio signal does not comprise said second position information), the second position information indicative of said second position of said transmitter is advantageously downloaded from said transmitter (e.g., after the aircraft have landed) or from a traffic monitoring service such as air traffic control.
Furthermore, the first position of the receiver (e.g., one's own aircraft) is measured, e.g., by means of a GNSS (such as a GPS receiver), and first position information, i.e., position information indicative of this first position of the receiver (e.g., own aircraft position in the above example) is derived.
As another step, said correction factor for said first estimation of said distance is derived using said first position information (e.g., own aircraft position), said second position information (e.g., foreign aircraft position), and said measured signal intensity. This step is advantageously carried out on-the-fly or “online”, e.g., repeatedly for one or more triples of first-position-information/second-position-information/signal-intensity datasets. As an alternative, the correction factor can be derived in a post-processing or “off-line” mode, e.g., after the aircraft with the receiver has landed and second position information datasets have been downloaded from the aircraft with the transmitter or from a traffic monitoring service such as air traffic control. In the second situation, the first-positioninformation/signal-intensity datasets (as, e.g., acquired during flight) are saved in a memory for the later post-processing derivation of the correction factor.

The described method has the advantage that a correction factor can be derived for improving the precision of future distance estimations which are solely based on radio signal intensities. For this, the correction factor is advantageously saved in a memory. In other words, for future second (i.e., improved, see below) disestimations, no knowledge of the second position (e.g., remote aircraft position) of the transmitter are necessary any more but a second distance estimation can now be derived using, e.g., a solely radio-signal-intensity-based first distance estimation or solely the radio signal intensity itself and the correction factor that has been derived in the first place. This method can also be applied to radio signals from different transmitters. Thus, radio signal intensities are calibrated using transmitted second position information and the precision of second distance estimations based on measured radio signal intensities is improved.

Advantageously, the first and/or the second position information, i.e., the position information about the receiver and/or the transmitter, is at least indicative of an altitude, a latitude, and a longitude each (3D positions). Optionally, the position information can comprise further parameters like velocity vectors, acceleration vectors etc. Thus, a a more precise distance value indicative of said true distance between the receiver and the transmitter can be derived using the first position information and the second position information. This distance value is then advantageously used in deriving said correction factor.

In another advantageous embodiment, the radio signal which is transmitted by said transmitter comprises an identifier, in particular a unique identifier. Thus, radio signals from different transmitters can be discriminated by the receiver. Optionally, radio signals can also comprise timestamps that enable the discrimination of different radio signals from the same transmitter.

In another advantageous embodiment, the method further comprises a step of deriving relative position information indicative of a relative position of the transmitter with regard to the receiver. This relative position information can, e.g., comprises a relative azimuth angle (φ), i.e., a relative horizontal bearing, and/or a relative inclination angle (θ), i.e., a relative vertical bearing. Then, the correction factor is derived using said relative position information or depending on the relative position of the transmitter with regard to the receiver. The relative position information can also be attached to the correction factor. In a preferred embodiment, a plurality of correction factors is derived for radio signals from different relative positions. Thus, the correction factors are, e.g., indicative of directional characteristics of a receiver antenna of the receiver and/or of a directional characteristics of a transmitter antenna of the transmitter. Thus, the reliability and precision of the second distance estimation can be further improved.

In yet another preferred embodiment, at least two correction factors are derived. On the one hand, more than one correction factor can be derived for the same transmitter at different times and/or at the same or different second positions, in the latter case preferably using different relative positions. Two or more correction factors can then be averaged to further enhance reliability of the second distance estimations. Alternatively or additionally, different correction factors can be derived for different transmitters (e.g., for more than one foreign aircraft). A combination of both approaches is possible as well. Optionally, a reception warning can be issued if two of the derived correction factors differ considerably, i.e., by more than 12 percent, from each other. Thus, failure scenarios can be more reliably detected.

Preferably, a subset or all of the derived correction factors can be combined to a relative-position-dependent correction function (i.e., an at least partly continuous mapping relation), e.g., comprising interpolation and/or extrapolation and/or averaging techniques. As an example, such a correction function can be derived that “wraps” the receiver position such that correction factors can be computed for all possible relative transmitter positions surrounding the receiver. Thus, second distance estimations become possible for more than the actually measured relative positions.

In another preferred embodiment, the method further comprises a step of deriving an output power value of the transmitter using the first (receiver) position information, the second (transmitter) position information, and the measured signal intensity. As an example, the above mentioned assumed 1/d² dependency (with d being the true distance) of radio signal intensity can be used for this. Thus, transmitter malfunctions may be detected and can be reported to the transmitter operator.

As another aspect of the invention, as soon as the correction factor and/or correction function is known, a method for deriving at least one second estimation of a distance between a first position (e.g., own aircraft position) of at least one receiver and a second position (e.g., foreign aircraft position) of at least one transmitter comprises the following steps:
Receiving by means of the receiver at the first position at least one radio signal which is transmitted by the transmitter at the second position.
Measuring a signal intensity of this (advantageously pre-filtered) radio signal at the first position (e.g., own aircraft position in the above example) of said receiver.
Optionally deriving said first estimation of said distance using the measured signal intensity, in particular solely using the measured signal intensity, of the received radio signal from the transmitter. In other words, no position information indicative of the second position is necessarily comprised in the radio signal.
Deriving said second estimation of said distance (or, in other words, improving the first distance estimation solely relying on the radio signal intensity) using said first estimation of said distance itself or, equivalently, using the measured signal intensity, and furthermore using at least one correction factor and/or a correction function as discussed above.

The terms “second estimation of a distance” or equivalently “second distance estimation” and “first estimation of a distance” or equivalently “first distance estimation” as used throughout the description are characterized in the following way: a deviation (in a statistical sense such as, e.g., variance or standard deviation) of the “first distance estimation” from the “true distance” between the first and the second position is larger than a deviation (in a statistical sense such as, e.g., variance or standard deviation) of the “second distance estimation” from the “true distance” between the first and the second position. Thus, the “second distance estimation” is “closer” (in a statistical sense) to the “true distance” than the “first distance estimation”: Thus, the second distance estimation is regarded as more reliable than the first distance estimation.

This improvement in precision is achieved by using a correction factor and/or correction function to derive the “second distance estimation” from the “first distance estimation” which (e.g., solely) relies on measuring the radio signal intensity or directly using the radio signal intensity. In other words, after such a correction factor and/or correction function has been derived in a first step (in which second position information is available), the disclosed method allows for the derivation of the second distance estimation (solely) relying on a measured radio signal intensity and the radio signal does not need to (although it can) comprise second position information any longer. In the case that both the first and the second position information is available, a positioning accuracy can be derived for the first and/or second positions and the second distance estimation can also take this positioning accuracy into account, e.g., via weighted averaging algorithms. Thus, the precision of the second distance estimation can be further improved.

The measured radio signal intensities are calibrated by the correction factor and/or correction function. Preferred examples for radio signals in aviation are
an ADS-B Out signal (from an ADS-B Out capable transponder),
a FLARM signal (from a FLARM system),
a Mode 3A or A response signal (from a transponder),
a Mode C response signal (from a transponder), and
a Mode S response signal (from a transponder).

Some of these radio signals do comprise second position information (ADS-B Out, FLARM). Then, the above disclosed method allows for comparing the second distance estimation with a true distance which can be derived from the first and second position information and/or for deriving positioning and thus distance accuracies (see above). On the other hand, some of these radio signals do not comprise second position information (Mode 3A or A) or at least not full second position information (Mode C, Mode S). In such a case, the above disclosed method enables the derivation of a second distance estimation based on solely measuring the radio signal intensities and applying the correction factor and/or correction function.

If the second distance estimation decreases below a distance threshold, a warning (e.g., visual and/or acoustic and/or tactile), in particular a collision warning, is advantageously issued to an operator. Thus, hazardous collision situations can be avoided.

More advantageously, the method further comprises a step of
Deriving an estimation of a future trajectory of the receiver (and thus, e.g., one's own aircraft flight path), in particular using said first position of said receiver, a current velocity of said receiver, and/or a current acceleration of said receiver and/or other flight data such as vertical velocities or wind speeds. These parameters are advantageously determined by flight control systems and input to a collision warning device (see below) via an interface. Alternatively or in addition, an estimation of a future trajectory of said transmitter (and thus, e.g., of foreign aircraft+ flight paths) is derived, in particular using said second position of said transmitter, a derived current velocity of said transmitter, and/or a derived current acceleration of said transmitter and/or other flight data. As an option to online estimating these parameters, at least a subset of them can be received encoded in the radio signal. Different trajectory calculation schemes can be applied for different flight situation such as, e.g., normal flight, thermalling, taxiing etc.

The method can further comprise a step of
Deriving an estimation of a future distance (i.e., second distance estimations for the future) between said receiver and said transmitter using a future trajectory of said receiver (or equivalent data) and/or using (a) future trajectory/-ies of said transmitter(s) (or equivalent data). An additional warning is issued when the estimation of the future distance decreases below the distance threshold. Thus, even more hazardous collision situation can be avoided.

Note: As an alternative to deriving the actual trajectories of the receiver and/or of the transmitter, the above mentioned data (position, current velocity, current acceleration, flight data) can be used directly in said step of deriving the estimation of the future distance between said receiver and said transmitter (“equivalent data”).

In another advantageous embodiment the warning is suppressed if an altitude of the transmitter differs more than 500 ft (i.e., 152.4 m), preferably 1000 ft (i.e., 304.8 m), more preferably 1500 ft (i.e., 457.2 m), from an altitude of the receiver. In other words, the warning is only issued if the altitude difference of the transmitter and the receiver are within a limit of, e.g., 1000 ft. This limit can also be user-settable, e.g., depending on an expected aircraft density and/or on safety needs.

Advantageously, the radio signal comprises an identifier, in particular a unique identifier of the transmitter. Thus, radio signals from different transmitters, e.g., of different aircraft can be discriminated.

In another advantageous embodiment, the method further comprises a step of
Deriving relative position information indicative of a relative position of the transmitter with regard to the receiver, e.g., by means of a directional receiver antenna. This relative position information particularly comprises a relative azimuth angle (i.e., a relative horizontal bearing) and/or a relative inclination angle (i.e., a relative vertical bearing).

Thus, the relative position of the transmitter with regard to the receiver can be determined.

If the correction factor and/or the correction function that is or are used for deriving the second distance estimation is or are also relative-position-dependent (i.e., if they depend on a relative position between the receiver and the transmitter and/or have relative position information attached), this information can then advantageously be used to select and/or evaluate the proper correction factor and/or correction function for the present situation/relative position. Thus, the reliability of the second distance estimation can be further improved as, e.g., directional characteristics of antennas can be taken into account.

Advantageously, the radio signal can be filtered prior to measuring the signal intensity. Suitable filtering methods can, e.g., comprise SAW-bandpass filters. This has the advantage that intensity measurements become more reliable and are less prone to noise.

As another aspect of the invention, a collision warning device, in particular for use in aviation, comprises at least one receiver at a first position (e.g., own aircraft position) with at least one receiver antenna for receiving at least one radio signal which is transmitted by at least one transmitter at a second position (e.g., foreign aircraft position). These positions are separated by a “true” variable distance.

Furthermore, the collision warning device comprises a localization device, in particular a GNSS (e.g., a GPS receiver), for measuring the (first) position of said receiver (e.g., own aircraft position in the above example) and deriving first position information indicative of this first position and/or for deriving first positioning accuracy.

The collision warning device further comprises an output unit (e.g., visual, acoustic, tactile) for issuing a warning, in particular a collision warning, to an operator, e.g., a pilot.

The collision warning device further comprises a control unit which is adapted and structured to carry out the steps of a method for deriving a correction factor and/or correction function as disclosed above. Furthermore, the control unit is adapted and structured to carry out the steps of a method for deriving at least one second estimation of said distance as disclosed above. Thus, such a collision warning device can be mounted in an aircraft and help to prevent hazardous collision conditions.

Advantageously, the collision warning device further comprises an interface for connecting it to a flight control system for receiving flight data. Such flight control data can, e.g., comprise current rudder positions, velocities, accelerations, and/or bearings of the aircraft. Thus, these parameters can be compared to parameters from the GNSS and/or used for trajectory pre-dictions (see above).

In another advantageous embodiment, the collision warning device further comprises a memory for storing derived correction factors and/or correction functions. Thus, these correction factors do not need to be re-derived for every flight. For offline-derivation of the correction factor(s) and/or correction function(s), the collision warning device can be adapted for storing time-resolved first position information and/or said signal intensity datasets.

The described embodiments and/or features similarly pertain to both the apparatuses and the methods. Synergetic effects may arise from different combinations of these embodiments and/or features although they might not be described in detail.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

FIG. 1 shows a top view of an air traffic situation involving 4 planes A, B, C, and D,

FIG. 2 shows a schematic of a collision warning device,

FIG. 3 shows a schematic of a correction function C for different relative azimuth anglesp.

### MODES FOR CARRYING OUT THE INVENTION

Description of the Figures:

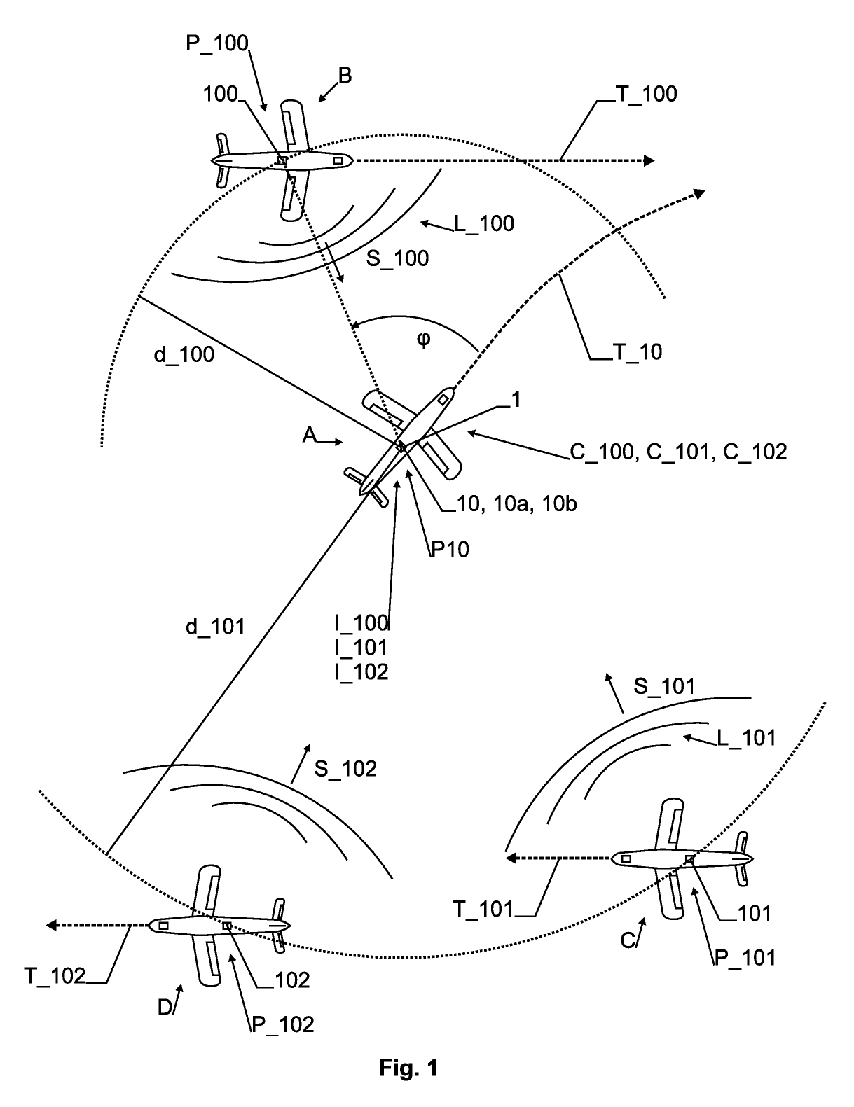

FIG. 1 shows a top view of an air traffic situation involving 4 aircraft A, B, C, and D. The aircraft A, B, C, and D can be of different types, e.g., comprising gliders, motor planes, commercial aircraft, paragliders, ultralight planes, gyrocopters, helicopters, etc.

At the shown point in time, aircraft A is at position P_10, aircraft B is at position P_100, aircraft C is at position R101, and aircraft D is at position P_102. Positions can, e.g., be defined by their latitude, longitude, and altitude. The true distances between the aircraft are d_100 between aircraft A and B and d_101 between aircraft A and C and between aircraft A and D (dotted circle segments). Radio signals S_100, S_101, and S_102 are transmitted from onboard transmitters/transponders 100, 101 and 102, respectively, and they comprise second position information L_100 for aircraft B and second position information L_101 for aircraft C, respectively. Second position information is indicative of the respective positions. No full second position information is transmitted from aircraft D (see below). Specifically, radio signal S_100 is a digital FLARM signal at, e.g., 868.4 MHz which encodes GPS position and altitude of aircraft C as well as an aircraft's identifier. Radio signal S_101 comprises a Mode S signal at, e.g., 1090 MHz and a to FLARM signal at, e.g., 868.2 MHz. The FLARM signal encodes the aircraft's GPS position and altitude as well as a identifier, whereas the Mode S signal only encodes altitude and identifiers. Radio signal S_102 is a Mode S signal which encodes the aircraft's altitude and identifiers but no GPS position.

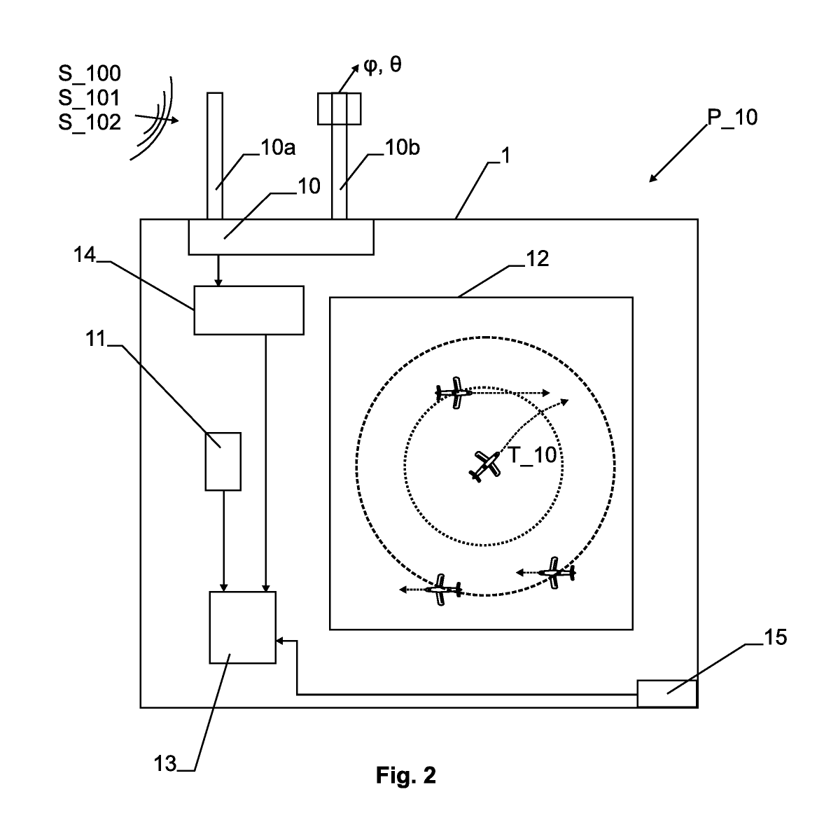

As it is schematically shown in FIG. 2, the collision warning device 1 of aircraft A receives the radio signals S_100, S_101, and S_102 by means of antennas 10a (for FLARM signals) and 10b (for ADS and SSR signals). Antenna 10b is a directional receiver antenna which is adapted to sense a direction of the received signals, i.e., a relative azimuth angle φ and a relative inclination angle θ. A common receiver 10 is connected to the antennas 10a and 10b for receiving the actual signals. Then, the radio signals are filtered and processed by a signal processing unit 14 and transmitted to a control unit 13. The control unit 13 also receives first position information L_10 indicative of the first position P_10 of aircraft A from a GPS unit 11. Other GNSS devices are suitable as well. Furthermore, the control unit 13 receives flight data such as, e.g., vertical velocity, acceleration data, and gyroscopic data from flight control systems via an interface 15. From all this information or at least a subset of this information, a future trajectory T_10 of aircraft A and estimated trajectories T_100, T_101, and T_102 for aircraft B, C, and D are derived by the control unit 13 (dashed arrows in FIG. 1). The document http://www.flarm.com/files/basic_presentation_en .ppt (as accessed on Jul. 25, 2012) gives details on this.

Furthermore, the control unit 13 measures signal intensities I_100, I_101, and I_102 of the received radio signals S_100, S_101, and S_102. Then, estimations of the distances d_100, d_101, and d_102 are derived using these measured radio signal intensities I_100, I_101, and I_102 assuming a 1/d² dependence of signal intensities.

As a next step, correction factors C_100, C_101, and C_102 are derived for calibrating the measured radio signal intensities by the control unit 13 using these distance estimates and - in the cases of the aircraft B and C - using the true distances as derived from the available first and second position information datasets. In the case of aircraft D where no second position information is available to the control unit 13, a measured signal intensity I_102 is similar to the intensity of the (SSR-part of the) radio signal S_101 from aircraft C when rotationally symmetric receiver and transmitter antenna characteristics are assumed. Thus, a correction factor C_102 for aircraft D is assumed to be similar to the correction factor C_101 for the SSR-signal from aircraft C (identical true distances d_101). As an additional option, relative position information between transmitter and receiver can be taken into account, e.g., for a specific azimuth angle or angular range φ and/or for a specific inclination angle or angular range θ (not shown).

In a next step, e.g., when aircraft C leaves and reenters a range for receiving radio signal S_101 (e.g., 2-5 km for FLARM signals, >10 km for SSR and ADS signals), a second distance estimation can be derived using a newly measured radio signal intensity and using the pre-derived correction factor as described above.

Then, the present traffic situation is displayed on an output unit 12 (screen) and a visual and acoustic warning is issued to the pilot of aircraft A if the pilot's own future trajectory T_10 and any of the future trajectories T_100, T_101, T_102 of the adjacent aircraft B, C, and D exhibit potential mid-air collision danger, i.e., if the projected trajectory distance decreases below a distance threshold of, e.g., 30 m. This warning is suppressed, however, if the altitudes of the respective aircraft differ by more than 100 ft (i.e., 30.5 m).

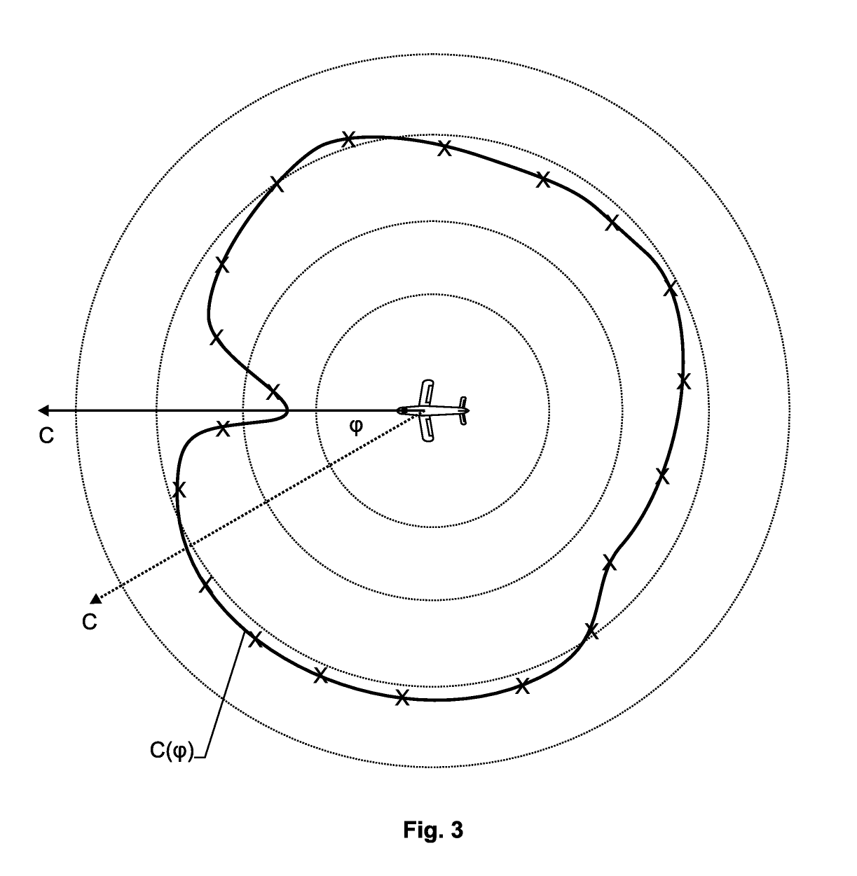

FIG. 3 shows a schematic of a correction function C for different relative azimuth angles φ. In other words, a plurality of correction values (“X”) is derived for different azimuth angles (or relative horizontal bearings) and interpolation is applied to gather a smooth correction function for all possible azimuth angles φ (thick line C(φ)). Thus, this correction function can be evaluated for any azimuth angle φ if a φ-resolved radio signal is received from which a second distance estimation is to be derived. A similar approach is suitable for different relative inclination angles θ (not shown).

Definitions:

The term “signal intensity” of the received radio signal is sometimes also referred to as “RSSI” or “Received Signal Strength Indication”.

The term “FLARM” relates to an electronic device, in particular for aviation, that periodically transmits information about its own position (latitude, longitude, and altitude) as well as an identifier over a digital radio transmitter (encoded in a FLARM signal). Optionally, other information such as future trajectory predictions can be comprised in the FLARM signal. See, e.g., http://en.wikipedia.org/wiki/FLARM as accessed on May 21, 2012 for further information.

The term “SSR” relates to “Secondary surveillance radar” interrogation and response signals (see, e.g., http://en.wikipedia.org/wiki/Secondary_surveillance_radar as accessed on May 15, 2012) which can be used for two-way communications between several aircraft and/or between a single aircraft and ground stations, typically using several frequencies. Different transponder modes exist, e.g., Mode C which encodes the altitude in 100 ft increments, or Mode S which additionally encodes, e.g., an identifier. Typically, transponders only transmit as a response (response signal) to an SSR-interrogation, but they can also transmit without prior interrogation.

The term “ADS” relates to “Automatic dependent surveillance” (see, e.g., http://en.wikipedia.org/wiki/Automatic Dependent Surveillance as accessed on May 15, 2012) which can also be used for two-way communications between several aircraft and/or a single aircraft and ground stations. An ADS-B Out signal is a periodically transmitted signal from an onboard transmitter in an aircraft which encodes identifiers, current position, altitude, and velocity.

### Summary of a Preferred Embodiment

An improved method for avoiding mid-air collision in aviation is disclosed. The method relies on a calibration of radio signal intensities I with radio signal encoded position information L. In other words, after a first reception of a radio signal S advantageously comprising remote aircraft position information L, the radio signal intensity I is measured and a correction factor C is derived. During a next encounter of the radio signal S, a second distance estimation d can be derived using the signal intensity I and the correction factor C. Preferably, relative positioning data is acquired together with the correction factor C and a plurality of correction factors for different relative positions is combined in an at least partly continuous correction function.

Notes:

Time-of-flight information of the radio signal between the transmitter and the receiver can in addition be used to derive the correction factor and/or to further improve the precision of the second estimation of the distance. For this, the radio signal comprises a time-stamp.

While there are shown and described presently preferred embodiments of the invention, it is to be distinctly understood that the invention is not limited thereto but may be otherwise variously embodied and practiced within the scope of the following claims.

1. A method for deriving at least one correction factor for at least one first estimation of a distance between a first position of at least one receiver and a second position of at least one transmitter, the method comprising:
receiving by means of said receiver at least one radio signal which is transmitted by said transmitter;
measuring a signal intensity of said radio signal at said first position of said receiver;
deriving second position information indicative of said second position of said transmitter;
measuring said first position of said receiver and deriving first position information indicative of said first position; and
deriving said correction factor for said first estimation of said distance using said first position information, said second position information, and said signal intensity.

2. The method of claim 1 further comprising:
deriving said first estimation of said distance using said signal intensity.

3. The method of any claim 1 wherein said first position informal ion is at least indicative of an altitude, a latitude, and a longitude of said /receiver and/or wherein said second position information is at least indicative of an altitude, a latitude, and a longitude of said transmitter.

4. The method of claim 1 wherein said radio signal further comprises an identifier, in particular a unique identifier, of said transm itter.

5. The method of claim 1 further comprising:
deriving relative position information indicative of a relative position of said transmitter with regard to said receiver, and in particular wherein said relative position information comprises a relative azimuth angle and/ora relative inclination angle,
wherein said correction factor is derived using said relative position information.

6. The method of claim 5 wherein said correction factor is indicative of directional characteristics of a receiver antenna of said receiver and/or of directional characteristics of a transmitter antenna of said transmitter.

7. The method of claim 1 further comprising:
deriving at least two correction factors (C _100, C_100′, C_101′).

8. The method of claim 7 wherein said correction factors are derived for the same transmitter at different times, and in particular wherein the method further comprises:
deriving an averaged correction factor using said correction factors.

9. The method of any claim 7 wherein said correction factors are derived for different transponders with different second positions.

10. The method of claim 7 further comprising:
issuing a reception warning if an absolute difference between said correction factors exceeds a threshold.

11. The method of claim 5 further comprising:
deriving at: least two correction factors; and
deriving a relative-position-dependent correction function using at least two of said correction factors and using said relative position information.

12. The method of claim 1 further comprising:
deriving a distance value indicative of said distance using said first position information and said second position information,
wherein said correction factor is derived using said distance value and said signal intensity.

13. The method of claim 1 further comprising:
deriving an output power value of said transmitter using said first position information, said second position information, and said signal intensity.

14. The method of claim 1 wherein said at least one transmitter comprises at least one of the group consisting of
an A DS-B Out capable transponder and
a HARM and a Mode C or a Mode S transponder and/or
wherein said radio signal comprises at least one of the group consisting of
an ADS-SB Out signal and
a FLARM and a Mode C signal.

15. The method of claim 1 wherein said radio signal comprises said second position information indicative of said second position of said transmitter.

16. The method of claim 1 wherein said second position information indicative of said second position of said transmitter is downloaded from said transmitter or from a traffic monitoring service, in particular from air traffic control.

17. A method for deriving at least one second estimation of a distance between a first position of at least one receiver and a second position of at least one transmitter, the method comprising:
receiving by means of said receiver at least one radio signal which is transmitted by said transmitter;
measuring a signal intensity of said radio signal at said first position of said receiver;
deriving said second estimation of said distance using said signal intensity, in particular solely using said signal intensity, and using at least one correction factor of claim 1 and/or a correction function of claim 11,
wherein a statistical deviation of said second estimation of said distance from said distance is smaller than a statistical deviation of said first estimation of said distance from said distance.

18. The method of claim 17 further comprising:
deriving said first estimation of said distance using, said signal intensity, in particular solely using said signal intensity.

19. The method of claim 17 further comprising:
issuing a warning, in particular a collision warning, to an operator when said second estimation of said distance decreases below a distance threshold.

20. The method of claim 17 further comprising:
deriving an estimation of a future distance between said receiver and said transmitter using said first position of said receiver, a current velocity of said receiver, and/or a current acceleration of said receiver and/or furthermore using said second position of said transmitter, a current velocity of said transmitter, and/or a current acceleration of said transmitter,
wherein a warning is additionally issued when said estimation of said future distance decreases below a distance threshold.

21. The method of claim 20 further comprising:
deriving an estimation of a future trajectory of said receiver, in particular using said first position of said receiver a current velocity of said receiver, and/or a current acceleration of said receiver, and/or
deriving an estimation of a future trajectory of said transmitter, in particular using said second position of said transmitter, a current velocity of said transmitter, and/or a current acceleration of said transmitter,
wherein said estimation of said future trajectory of said receiver and/or said estimation of said future trajectory of said transmitter is or are used in said step of de-riving said estimation of said future distance between said receiver and said transmitter.

22. The method of claim 19 further comprising:
suppressing said warning if an altitude of said transmitter differs more than 152.4 m, particularly 304,8 m, in particular 457.2 m, from an altitude of said receiver.

23. The method of claim 17 wherein radio signal further comprises an identifier, in particular a unique identifier, for identifying said radio signal of said transmitter.

24. The method of claim 17 further comprising:
deriving relative position information indicative of a relative position of said transmitter with regard to said receiver, and in particular wherein said relative position information comprises a relative azimuth angle ((p) and/or a relative inclination angle.

25. The method of claim 24 wherein said correction factor and/or said correction function is or are dependent on said relative position of said transmitter with regard to said receiver and wherein said correction factor and/or said correction function for deriving said second estimation of said distance is or are selected and/or evaluated using said relative position information.

26. The method of claim 17 further comprising:
filtering said radio signal prior to carrying out said step of measuring said signal intensity.

27. The method of claim 17 wherein said at least one transmitter comprises at least one of the group consisting of
an ADS-B Out capable transponder,
a FLARM system,
a Mode 3A or A capable transponder,
a Mode C capable transponder, and
a Mode S capable transponder and/or
wherein said radio signal comprises at least one of the group consisting of
an ADS-B Out signal,
a FLARM signal.
a Mode 3A or A signal,
a Mode C signal, and
a Mode S

28. A collision warning device, in particular for use in aviation, comprising:
at least one receive at a first position with at least one receiver antenna for receiving at least one radio signal which is transmitted by at least one transmitter at a second position, wherein said first position and said second position are separated by a variable distance;
a localization device, in particular a GNSS receiver, for measuring said first position of said receiver and deriving first position information indicative of said first position;
an output unit for issuing a warning, in particular a collision warning, to an operator,
a control unit adapted and structured to carry out the steps of a method of claim 1 for deriving at least one correction factor and to carry out the steps of a method of claim 17 for deriving at least one second estimation of said distance.

29. The collision warning device of claim 28 further comprising an interface for connecting said collision warning device to a flight control system for receiving flight data, in particular a current velocity and/or a current acceleration and/or a current bearing and/or a current rudder position, from said flight control system.

30. The collision warning device of claim 28 further comprising a memory for storing said correction factor and/or said correction function and/or said first position information and/or said signal intensity.
